(19) United States
(12) Patent Application Publication
(10) Pub. No.: US 2005/0010390 A1
(43) Pub. Date: Jan. 13, 2005

(54) Translated expression extraction apparatus, translated expression extraction method and translated expression extraction program

(75) Inventor: Sayori Shimohata, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/849,788

(22) Filed: May 21, 2004

(30) Foreign Application Priority Data
May 28, 2003 (JP) 2003-150770

(51) Int. Cl. G06F 17/28

(52) U.S. Cl. 704/5

(57) ABSTRACT

There is provided a translated expression extraction apparatus, which comprises a corpus storage section; a translated expression storage section; a degree of similarity calculation section for calculating degree of similarity while comparing co-occurrence conditions between first candidate wording and wording of the first language registered in the translated expression storage section, with co-occurrence conditions between second candidate wording and wording of the second language registered in the translated expression storage section; and an additional registration section in which the first candidate wording and the second candidate wording with high degree of similarity, are associated with each other, and then additionally registered in the translated expression storage section as a new translated expression, wherein additional registration of the new translated expression is performed upon operating the above sections on the basis of the translated expression storage section, after having performed the additional registration.

### BACKGROUND OF THE INVENTION

The present invention relates to a translated expression extraction apparatus, a translated expression extraction method and a translated expression extraction program, which are-suitable for, for example, the case of extracting translated expressions from corpora of two languages with sentence correspondence (correspondence between sentences) uncompleted.

### DESCRIPTION OF THE RELATED ART

The known method for extracting translated expressions from the corpus, generally, is the method in which a pair of words appearing on corresponding sentences is made to extract by using a two-language corpus (parallel corpus) with the sentence correspondence completed. However, the above-described method has the problems for practical use, because the method has the limited scope of application caused by a small amount of the parallel corpora, which exist practically.

While, disclosed is the method for extracting translated expressions from the corpora of two languages with sentence correspondence uncompleted, which is described in non-patent document 1 below. This method performs extraction of the translated expressions under the idea that a pair of the words of co-occurring in certain language co-occurs in another language. Namely, this method extracts co-occurrence pattern between the word in the word list in each language and a translation-objective word with correspondence thereto (hereinafter referred to as candidate word) upon using the word list of two languages with correspondence each other; and extracts candidate word pair with similar co-occurrence pattern between two languages as the translated expressions.

Generally, “co-occurrence” is a state, in which a certain word and a certain word appear within a given range (for example, within a sentence or paragraph) simultaneously. Here, remarked is the candidate word, and co-occurrence is that one or plural words within the word list appear within a given range with respect to the candidate word.

In “Finding Terminology Translations from Non-parallel Corpora” (Proceedings of 5th International Workshop of Very Large Corpora (WVLC-5), Pages 192-202, Hong Kong, August 1997) (hereinafter referred to as non-patent document 1), the corpus is defined. Although the corpus of being used may be one which has the same content, and belongs to the same field, however, the corpora are not necessarily required to be the parallel corpora. Many corpora exist in the shape of such corpus, therefore, the method using the non-parallel corpus has wide scope of application and the method is practical, in comparison with the method of using the parallel corpora.

However, in the disclosed method of the non-patent document 1, in which the word list is fixed (unchanged), there may occur the case that only the small number of translated expressions can be extracted depending on size of the corpus or kind of word included in the corpus. Extraction efficiency of the translated expression is poor.

The translated expression becomes useful language resources on process of natural language, for example, in utilizing it to dictionary. Consequently, it is important to enhance efficiency at the time of extracting the translated expression from the corpus.

### SUMMARY OF THE INVENTION

In order to solve these problems, a translated expression extraction apparatus according to the first invention comprises: (1) a corpus storage section for storing corpora of a first language and a second language; (2) a translated expression storage section in which wording of the first language and wording of the second language, whose correspondence relationship has previously been confirmed, are associated with each other to register therein as translated expression; (3) a degree of similarity calculation section which calculates degree of similarity indicating height of similarity of respective co-occurrence conditions while comparing co-occurrence conditions between first candidate wording to be wording extracted from the first language corpus and one kind or plural kinds of the wording of the first language registered in the translated expression storage section, with co-occurrence conditions between second candidate wording to be wording extracted from the second language corpus and one kind or plural kinds of the wording of the second language registered in the translated expression storage section; and (4) an additional registration section in which the first candidate wording and the second candidate wording, which have relationship that the degree of similarity obtained by the degree of similarity calculation section as calculation result is higher value than predetermined threshold value, are associated with each other, and then it is additionally registered in the translated expression storage section as a new translated expression, wherein, (5) the new translated expression is made to register additionally while operating the degree of similarity calculation section and the additional registration section on the basis of the translated expression storage section, after having performed the additional registration.

Further, a translated expression extraction method according to the second invention comprises the steps of: (1) storing corpora of a first language and a second language in a corpus storage section, and associating wording of the first language with wording of the second language, whose correspondence relationship has previously been confirmed, and registering them in the translated expression storage section as the translated expression; (2) calculating degree of similarity indicating height of similarity of respective co-occurrence conditions upon comparing co-occurrence conditions between first candidate wording to be wording extracted from the first language corpus and one kind or plural kinds of wording of the first language registered in the translated expression storage section by the degree of similarity calculation section, with co-occurrence conditions between second candidate wording to be wording extracted from the second language corpus and one kind or plural kinds of wording of the second language registered in the translated expression storage section; (3) associating the first candidate wording with the second candidate wording, which have relationship that the degree of similarity obtained by the degree of similarity calculation section as calculation results are higher value than predetermined threshold value, and additionally registering in the translated expression storage section as a new translated expression by the additional registration section, and (4) performing additional registration of the new translated expression while operating the degree of similarity calculation section and the additional registration section on the basis of the translated expression storage section, after having performed the additional registration.

Furthermore, a translated expression extraction program according to the third invention, which causes a computer to realize functions, comprises: (1) a corpus storage function for storing corpora of a first language and a second language; (2) a translated expression storage function in which wording of the first language and wording of the second language, whose correspondence relationship has previously been confirmed, are associated with each other to register as translated expression; (3) a degree of similarity calculation function which calculates degree of similarity indicating height of similarity of respective co-occurrence conditions, upon comparing co-occurrence conditions between first candidate wording to be wording extracted from the first language corpus and one kind or plural kinds of wording of the first language registered by the translated expression storage function, with co-occurrence conditions between second candidate wording to be wording extracted from the second language corpus and one kind or plural kinds of wording of the second language registered by the translated expression storage function; and (4) an additional registration function for associating the first candidate wording with the second candidate wording, which have a relationship that the degree of similarity obtained by the degree of similarity calculation function as calculation result is higher value than predetermined threshold value, and then it causes the translated expression storage function to register additionally as a new translated expression, (5) wherein an additional registration of the new translated expression is made to perform while operating the degree of similarity calculation function and the additional registration function on the basis of the translated expression storage function, after having performed the additional registration.

As described above, according to the present invention, it is possible to enhance efficiency of extraction (additional registration) of the translated expression.

### BRIEF DESCRIPTION OF THE DRAWINGS

FIG. 1 is a schematic diagram showing the entire configuration example of a translated expression collection system for use in a first embodiment;

FIG. 2 is a flow chart showing operation example of the first embodiment;

FIG. 3 is a flow chart showing operation example of the first embodiment;

FIG. 4 is a flow chart showing operation example of the first embodiment;

FIG. 5 is a diagram explaining operation of the first embodiment;

FIG. 6 is a diagram explaining operation of the first embodiment;

FIG. 7 is a diagram explaining operation of the first embodiment;

FIG. 8 is a diagram explaining operation of the first embodiment;

FIG. 9 is a diagram explaining operation of the first embodiment;

FIG. 10 is a diagram explaining operation of the first embodiment;

FIG. 11 is a schematic diagram showing the entire configuration example of a translated expression collection system for use in a second embodiment;

FIG. 12 is a flow chart showing operation example of the second embodiment;

FIG. 13 is a flow chart showing operation example of the second embodiment;

FIG. 14 is a diagram explaining operation of the second embodiment;

FIG. 15 is a diagram explaining operation of the second embodiment; and

FIG. 16 is a diagram explaining operation of the second embodiment.

### DETAILED DESCRIPTION OF THE PREFERRED EMBODIMENT

(A) Embodiment

Hereinafter, there will be explained about embodiments of a translated expression extraction apparatus, a translated expression extraction method and translated expression extraction program according to the present invention.

Common characteristic through the first and the second embodiments is one in which the translated expression is specified and added, after that, specifying and adding the translated expression are further repeated upon utilizing the entire translated expression gathering including the added translated expression.

(A-1) Configuration of the First Embodiment

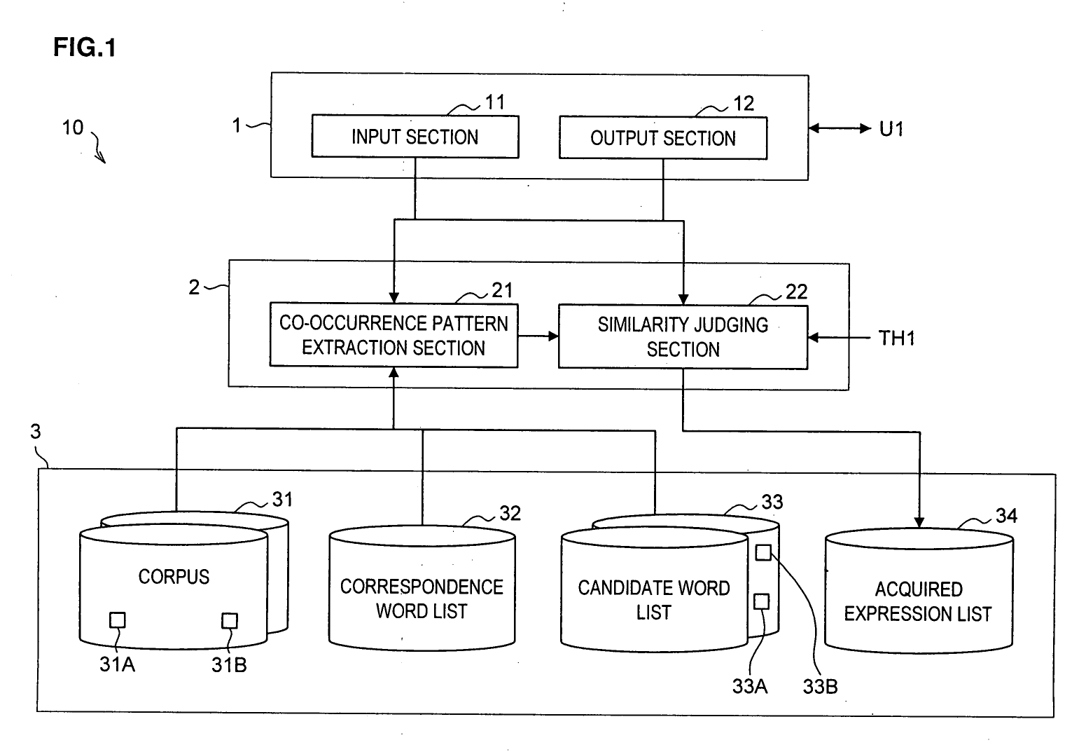

FIG. 1 shows the entire configuration example of a translated expression collection system 10 according to the present embodiment.

In FIG. 1, the translated expression collection system 10 comprises an input/output device 1, a processing device 2 and a storage device 3.

The input/output device 1 of this system comprises an input section 11 and an output section 12.

The input section 11 is a section which can be constituted by various functions such as, for example, pointing device of a keyboard or a mouse, character recognition processing due to the scanner, voice recognition processing due to the microphone, and the input section 11 functions at the time the user U1 performs various input operations.

The output section 12 is a section which can be constituted by various kind of functions such as for example, indication for the display device, conversion for the voice, voice output to provide various kind of information for the user U1. Here, the user U1 may be an operator for operating the translated expression collection system 10.

However, the input section 11 and the output section 12 not only function as interface for the user U1 to be a human being therebetween, but also may function to perform exchange of data or control information for remote or local information processing device (not illustrated) therebetween. It is suitable that contents and the like of later described corpus 31 are subjected to increasing and decreasing, or variation depending on exchange between the user U1 or the information processing device and the input section 11 or the output section 12.

For example, the mentioned is that, as example of exchange for the remote information processing device, Web page and the like obtained from Web server on Internet are made to add as the corpus at any time. Only the parallel corpus is used, the number thereof is limited. However, in the present embodiment is applicable to not only the parallel corpus but also the corpus of two languages without sentence correspondence. Consequently, the present embodiment applicable to the case that only the contents have relationship of the original and its translation, even though correspondence relationship of the sentences between the original and its translation is not necessarily precise, because of free translation. Such contents can be acquired from many Web servers arranged with distribution on the Internet.

Furthermore, condition on the corpus 31 is relaxed, so that if a composition has similar content of belonging to the same field (the same category), there is possibility to utilize it as the corpus of the present embodiment even though the composition has not necessarily relationship of the original and its translation.

The storage device 3 is constituted by hardware-based hard disk, nonvolatile storage means such as optical disk, or volatile storage means such as memory or the like, and software-based dictionary or list or the like, and the storage device 3 is of a section of containing and storing information with corresponding mode to various kind of data structure.

The storage device 3 is provided with a correspondence word list 32, a candidate word list 33, and an acquired expression list 34 other than the corpus 31.

The corpus 31 is the gathering of the language material to be the parent body of the translated expression, which the present embodiment attempts to collect, when seeing from point of diagram of the natural language, and the corpus 31 is offered in the shape of the database in order to facilitate searching operation and the like to the gathering.

The corpus (two-language corpus) 31 may involve many compositions, and it is possible to divide the corpus under the point of diagram of difference of language. One is the first language corpus 31A, and the other is the second language corpus 31B. It is possible to select various languages for the first language or the second language. Here, it is assumed that Japanese is selected as the first language, and English is selected as the second language.

In the present embodiment, it may be desired to have establishment of precise sentence correspondence (to be parallel corpus) between the corpus 31A of the first language and the corpus 31B of the second language in order to extract translated expression with high quality. However, as described above, it is not necessarily indispensable condition. Namely, the present embodiment is applicable to the case where relationship of the sentences between the first language corpus 31A and the second language corpus 31B is not precise because of free translation. Furthermore, the present embodiment has possibility to be applicable to the case in which even though the first language corpus 31A and the second language corpus 31B have not necessarily relationship of the original and its translation, if the composition is similar composition with respect to the content, such as the composition is one with the same field (the same category).

When sentences have a relationship of the original and its translation, properly, the field to which the first language corpus 31A and the field to which the second language corpus 31B are of the same fields. Consequently, to belong to the same field is the lowest condition to be satisfied with respect to relationship of the first language corpus 31A and the second language corpus 31B in the present embodiment. Various kinds of matters are capable of being selected as the field, and the present embodiment selects “baseball” as one example.

In this case, as a specific example of the corpus 31A and the corpus 31B, what can be remarked is, for example, Japanese news paper items concerning the base ball (corresponding to corpus 31A) and its English version news paper items (corresponding to corpus 31B).

The correspondence word list 32 is a list for storing translated expression (expression pair) of the two languages whose correspondence relationship is confirmed previously. The correspondence word list 32 is not necessarily to realize itself while using list structure as the data structure. However in this embodiment, since addition of pair of the translated expression is mainly repeated therein, it is possible to perform addition operation with fixed processing amount without depending on component number (the number of translated expression) included in the list structure. In this meaning, the present embodiment realizes a correspondence word list 32 using a list structure as the data structure.

Assuming that the list structure is of unidirectional list accompanied with a special pointer (list header) for specifying leading element (each element includes one (a pair of) translated expression). Here, it is desired to perform element addition (additional registration of translated expression) to leading section of the unidirectional list under the viewpoint for reducing processing amount. Since only the pointer (not illustrated) included in each element on the unidirectional list specifies front/rear relation on the list, in order to reach an element other than the lead, linear search following every one element sequentially is made to execute from leading element.

Contents of the correspondence word list 32 include various kinds of matters. As one example, they may be matters as shown in FIG. 6. In the example in FIG. 6, expression pair of the correspondence word list 32 belongs to “baseball” field. In the constitution of the present embodiment, required is that certain degrees of the number of translated expressions belonging to “baseball” field are registered in the correspondence word list 32 from the initial state. However, it may be permitted that translated expressions not belonging to “baseball” field are registered. It is suitable that the user U1 may register the certain degrees of the number of translated expressions belonging to “baseball” field desired at the initial state via the input/output device 1 if necessary.

In the example of FIG. 6, one translated expression (for example, a translated expression constituted from “ [symbol] (bu-ru-pe-n)” (means bull pen in Japanese) and “bull pen”) is one element, and operations such as addition, searching, deletion and the like can be performed with these elements as the unit.

In the candidate word list 33, the same matters as the correspondence word list 32 are valid in reference to the “list”. However, the word registered in the candidate word list 33 is merely a word cut down from the first language corpus 31A or the second language corpus 31B upon performing morphological analysis, consequently, the word is one whose correspondence relationship is unconfirmed.

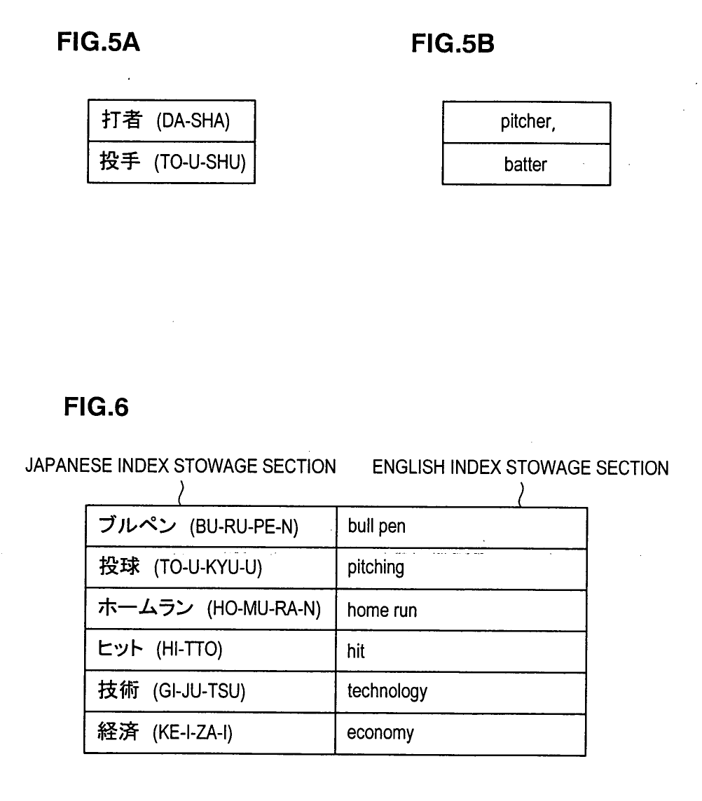

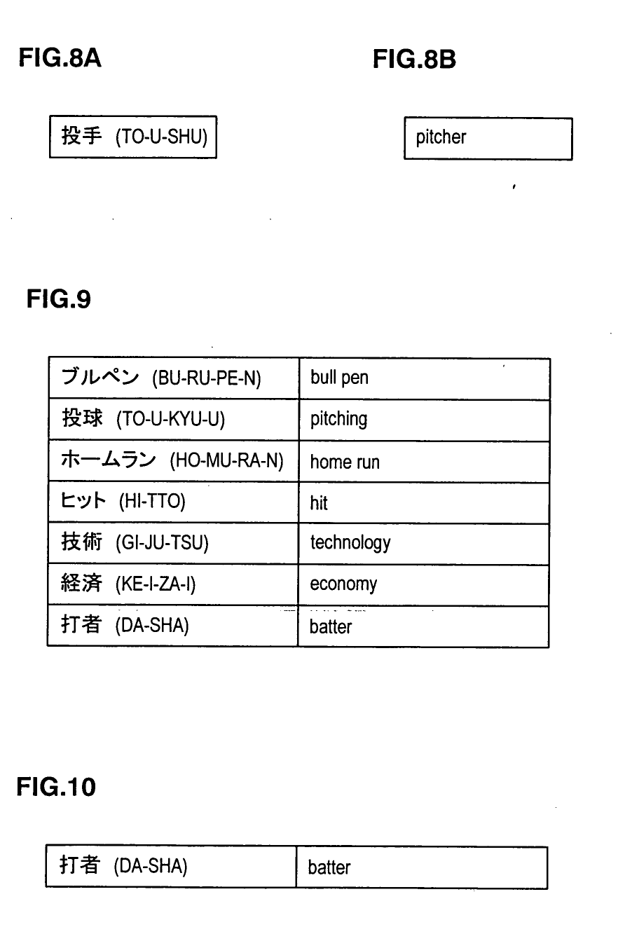

This way, since correspondence relationship is not confirmed, the candidate word list 33, like the corpus 31, has the first language candidate word list 33A and the second language candidate word list 33B. As one example, the indicated in FIG. 5(A) may be suitable for the first language candidate word list 33A and the indicated in FIG. 5(B) may be suitable for the second language candidate word list 33B. Or, the indicated in FIG. 8(A) may suitable for the first language candidate word list 33A and the indicated in FIG. 8(B) may be suitable for the second language candidate word list 33B.

The acquired expression list 34 is a list for registering acquired expression (translated expression) gathered newly, in which correspondence relationship is confirmed with a translated expression collection system 10, and fundamentally the acquired expression list 34 has the same structure as the correspondence word list 32. In the constitution of the present embodiment, the acquired expression list 34 is not necessarily indispensable. However, when using the acquired expression list 34, it is possible easily to discriminate the translated expression gathered newly on the present embodiment from the translated expression already registered in the correspondence word list 32.

There may occur that a plurality of second language candidate words are extracted to one first language candidate word. In this case, for example, the method employed is to store only word with higher similarity into the acquired expression list 34, and the method employed is that a plurality of candidate words are represented via the output section 12 to the user U1, then the selected by the user U1 is stored in the acquired expression list 34, as a result, it is possible to maintain correspondence relationship of one by one between the first language and the second language among the translated expressions.

For example, the indicated in FIG. 10 may be suitable for the acquired expressions registered in the acquired expression list 34.

The processing device 2 which is provided with a calculation device such as CPU (central processing unit), a memory as operating storage means and a control section (including OS (operating system) and the like, if necessary), has a co-occurrence pattern extraction section 21 and a similarity judging section 22.

The co-occurrence pattern extraction section 21 is a section for performing extraction of the co-occurrence pattern. Here, the state in which two words appear simultaneously within a fixed range (sentence, paragraph, chapter and the like) is co-occurrence. The expressed numerically of tendency of co-occurrence of the word with characteristic vector mode is of co-occurrence pattern, and it is extracted every candidate word stored in the candidate word list 33. The characteristic vector is the information indicating how co-occurs between certain candidate word and a correspondence word (for example, “ [symbol] (bu-ru-pe-n)” in the case of translated expressions constituted by “ [symbol] (bu-ru-pe-n)” and “bull pen”) to be one of the translated expressions stored in the correspondence word list 32. If the candidate word is a word belonging to, for example, the first language, properly, the correspondence word is selected from the first language.

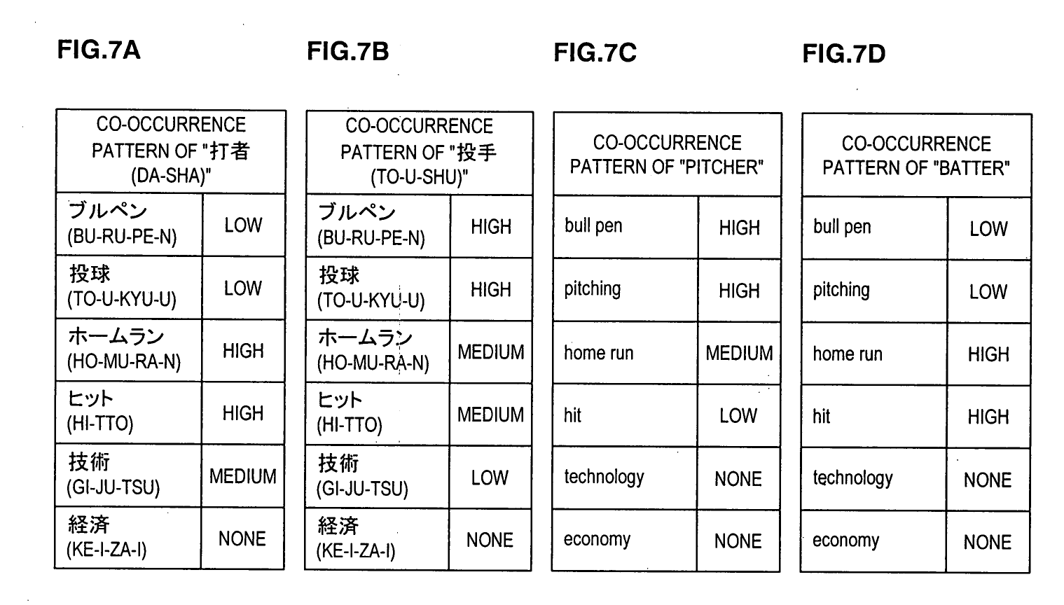

As one example, FIGS. 7(A) to 7(D) illustrate the co-occurrence pattern every candidate word.

For example, in FIG. 7(A), the investigated is co-occurrence frequency between candidate word “ [symbol] (da-sha)” (means batter in Japanese) and correspondence word group “ [symbol] (bu-ru-pe-n)”, “ [symbol] [symbol] (to-u-kyu-u)” (means pitching in Japanese), “ [symbol] (ho-mu-ra-n)” (means home run in Japanese), “ [symbol] (hi-tto)” (means hit in Japanese), “ [symbol] (gi-ju-tsu)” (means technology in Japanese) and “ [symbol] (ke-i-za-i)” (means economy in Japanese). As a result of the investigation, the indicated is that “ [symbol] (ho-mu-ra-n)” and “ [symbol] [symbol] (hi-tto)” have high co-occurrence frequency, “ [symbol] (gi-ju-tsu)” has medium co-occurrence frequency, “ [symbol] (bu-ru-pe-n)” and “ [symbol] (to-u-kyu-u)” have low co-occurrence frequency, and “ [symbol] (ke-i-za-i)” has no co-occurrence frequency (not co-occur).

As the forming method of the characteristic vector showing the co-occurrence pattern, it is possible to use vector capable of indicating a state whether or not a word co-occurs with each another word, which is indicated by using attributive value of “1” and “0”, here, the used is the real number vector other than the above vector, with the co-occurrence frequency as attribute. The specific content of patterns: “high”, “medium”, “low” and “none” as illustrated in FIG. 7 corresponds to the real number vector.

The similarity judging section 22 is a section having function for determining its similarity while comparing the co-occurrence patterns of candidate words between two languages. Here, as described above, the utilized is the idea that the word pair co-occurring in certain language (for example, Japanese as the first language) co-occurs also another language (for example, English as the second language).

For example, the first language “ [symbol] (da-sha)” (means batter in Japanese) corresponds to the word of the second language “batter” to constitute one translated expression. Here, as is clear from comparison between FIG. 7(A) and FIG. 7(D), the co-occurrence pattern of “ [symbol] (da-sha)” is considerably similar to the co-occurrence pattern of “batter” in that the co-occurrence frequency to correspondence word “ [symbol] (gi-ju-tsu)” (technology) is different from each other, thus “ [symbol] (da-sha)” is not equal to “batter”, however, the co-occurrence frequency to the another correspondence words other than the above matter is identical.

The similarity judging section 22 is a section for calculating degree of such similarity with predetermined calculation method, when obtained similarity of pair of candidate words exceeds predetermined threshold value TH1, the pair of the candidate words is made to store in the acquired expression list 34 as the acquired expression, and also is made to store in the correspondence word list 32 as the translated expression. Here, the acquired expression is equal to the translated expression.

As a calculation method for calculating similarity, it is conceivable that, for example, the method for obtaining Euclidean distance between co-occurrence patterns, and the method for obtaining cosine measure and the like are made to use. Here, the similarity is calculated upon counting the number of the correspondence words whose phase of the co-occurrence frequency such as “high”, “medium” or “low” or the like coincides with each other.

For example, in the example of FIG. 7(A) and FIG. 7(D), since the phase of the co-occurrence of five correspondence words other than “ [symbol] [symbol] (gi-ju-tsu)” (technology) among six correspondence words coincides with each other, “5” becomes the similarity of the co-occurrence pattern of “ [symbol] (da-sha)” and co-occurrence pattern of “batter”.

The co-occurrence frequency phase indicates co-occurrence strength. Upon performing statistical processing, if necessary, the correspondence word with the higher frequency of the co-occurrence within the corpus 31, whose phase of the co-occurrence frequency approaches “high”.

Furthermore, the threshold value TH1 is capable of being set to various kinds of values. As shown in FIG. 6, if the number of translated expression is degree of 6, the threshold value TH1 may suitably be set to degrees of 4 or 3.

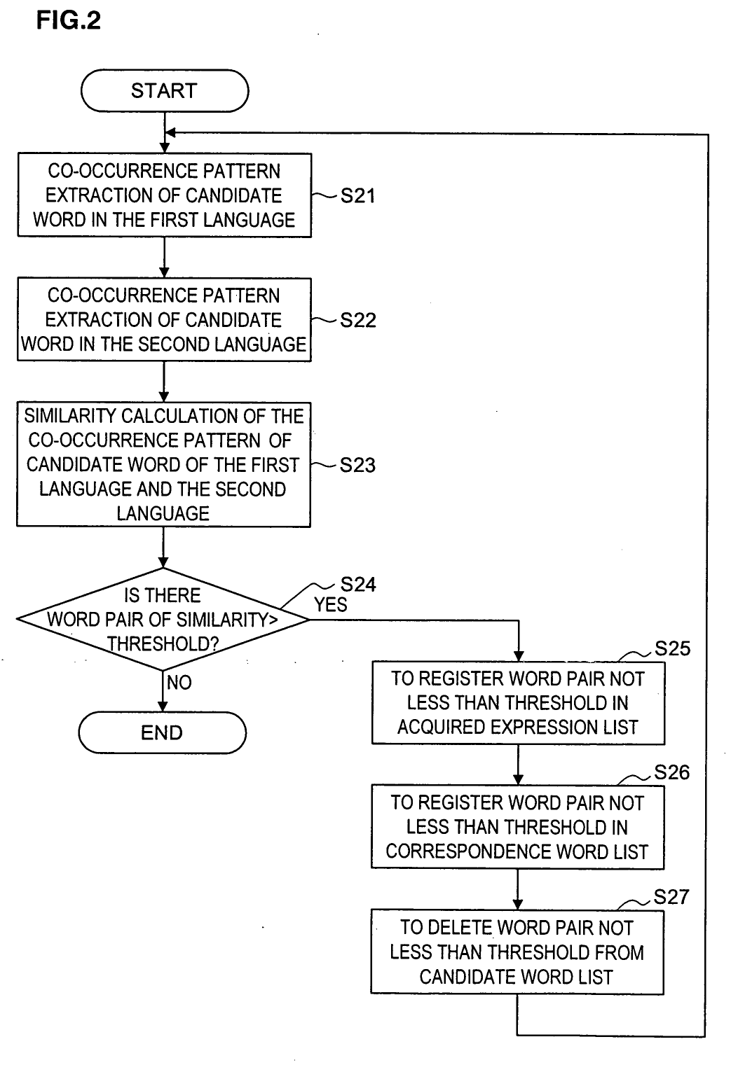

Hereinafter, there will be explained operation of the present embodiment having above described constitution with reference to flow charts of FIG. 2 to FIG. 4.

The flow chart of FIG. 2 indicates the whole processing flow, and which is provided with respective steps of S21 to S27.

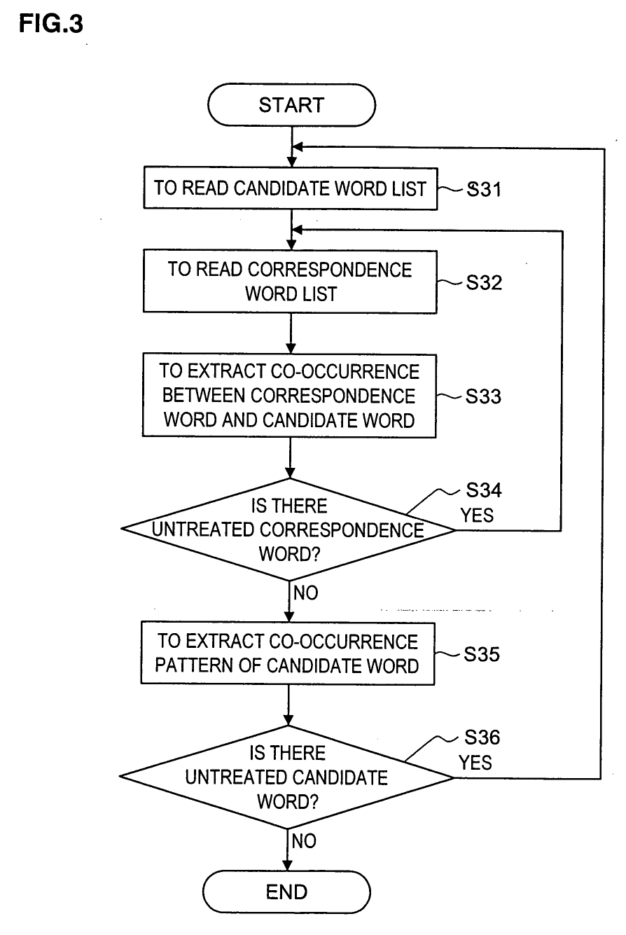

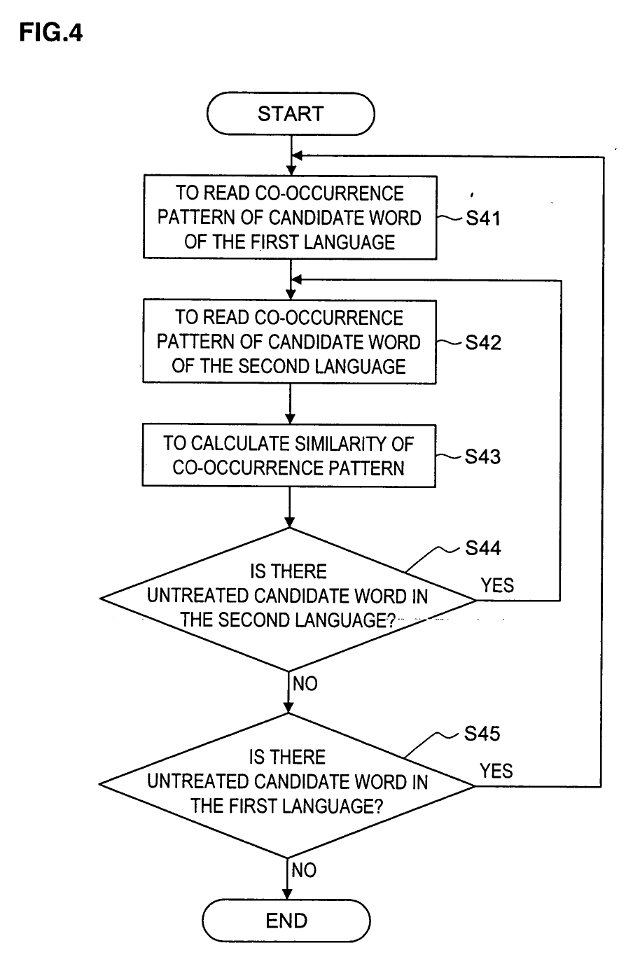

On the other hand, a flow chart of FIG. 3 shows processing flow of a co-occurrence pattern extraction section 21, and which is provided with respective steps of S31 to S36. Likewise, the flow chart of FIG. 4 is a flow chart showing processing flow of the similarity judging section 22; and which is provided with respective steps of S41 to S45.

(A-2) Operation of the First Embodiment

In FIG. 2, candidate words of respective languages are stored in the first language candidate word list 33A and the second language candidate word list 33B within the candidate word list 33, and the co-occurrence pattern extraction is performed about respective candidate words stored in the list by the co-occurrence pattern extraction section 21 (S 21, S 22).

Next, the similarity judging section 22 counts the number of correspondence words, in which phase of the co-occurrence frequency coincides with, and it examines presence of the candidate word pair whose similarity exceeds predetermined threshold value TH1 (S23, S24). The processing of this step S23 is repeated until the processing in connection with possible combination (pair) of the whole candidate words remaining in the candidate word list 33 is terminated. When there is no candidate word pair whose similarity exceeds the threshold value TH1 as a result of examination of the step S24, step S24 branches to “no” side to terminate processing. In this case, desired candidate word pair (namely, translated expression) cannot be obtained unless the first language corpus 31A and the second language corpus 31B are changed or the initial state of the correspondence word list 32 is changed.

On the other hand, when the step S24 branches “yes” side, the candidate word pair is stored in the acquired expression list 34 as the acquired expression and it is stored in the correspondence word list 32 as the translated expression (S25, S26). The candidate word pair stored in the acquired expression list 34 or the correspondence word list 32 is deleted from the candidate word list 33 as processing completed.

For example, in the case of the example of FIG. 7(A) to FIG. 7(D), “5” is counting result in pair of the candidate words “ [symbol] (da-sha)” and “batter”, while “1” is counting result in pair of the candidate words “ [symbol] [symbol] (da-sha)” and “pitcher”. Further, “1” is counting result in pair of the candidate words “ [symbol] (to-u-shu)” (means pitcher in Japanese) and “batter”, while “4” is counting result in pair of the candidate words “ [symbol] [symbol] (to-u-shu)” and “pitcher”.

Consequently, in this case, if the threshold value TH1 is three, step S24 branches “yes” side, in connection with pair of the candidate word “ [symbol] (da-sha)” and “batter” and pair of the candidate word “ [symbol] (to-u-shu)” and “pitcher”.

This way, two (two pairs) of translated expressions, namely the translated expression to be a pair of “ [symbol] (da-sha)” and “batter” and the translated expression to be a pair of “ [symbol] (to-u-shu)” and “pitcher” can be stored once in storing of translated expression according to step S26, which is performed with respect to the correspondence word list 32. The number of translated expression stored once varies depending on content of the corpus 31 or content of the correspondence word list 32, and there may occur the case in which only one translated expression is stored, however in many cases, a plurality of translated expressions are stored once as this example.

This way, since the translated expression in the correspondence word list 32 increases in every time the translated expression is registered, even though the processing is a processing to the corpus 31 with the same content, the details of processing content of step S21 to S24 vary in every repetition of the loop constituted by step S21 to S27. Consequently, it becomes possible to extract more preferable translated expression.

For this reason, although there have been the candidate word pair, which cannot be acquired because of poor calculated similarity in the processing where the number of registered translated expression is small, to the contrary, such candidate word pair may be acquired as the translated expression with high possibility in the processing where the number of the translated expression in the correspondence word list 32 increases.

For example, even though the initial state of the correspondence word list 32 is indicated in FIG. 6, the state becomes a state indicated in FIG. 9 after the translated expressions (the pair of “ [symbol] (da-sha)” and “batter”) are stored therein at step S26. Consequently, in the next processing, executed is processing of step S21 to S24 while using the correspondence word list 32 in the state with FIG. 9. This way, in the case that the state of FIG. 6 is changed to the state of FIG. 9, desired is constitution in which the position of the lower end section (the pair of “ [symbol] (ke-i-za-i)” and “economy”) in FIG. 6 corresponds to leading part of the above-described unidirectional list.

Desired is that when the number of the translated expression in the correspondence word list 32 increases, the threshold value TH1 is made to increase, while adjusting thereto. For example, although the number of the registered translated expression in the correspondence word list 32 reaches hundreds, if the threshold value TH1 is “3” as it is, possibility of registering candidate word pair should not be registered primarily as translated expression becomes high.

On the other hand, the flow chart in FIG. 3 showing operation of the co-occurrence pattern extraction section 21, under the relationship with the flow chart in FIG. 2, may also indicate details of the step S21 or S22 in FIG. 2.

In FIG. 3, the co-occurrence pattern extraction section 21 performs the reading (S31) of the candidate word from the candidate word list 33 and the reading (S32) of the translated expression from the correspondence word list 32; and it extracts the correspondence word and the candidate word with co-occurrence relationship (S33). The processing of the step S32 and S33 is repeated until the untreated correspondence word is out (yes side branch of S34). Consequently, the loop of the step S32 to S34, when the correspondence word list 32 is in initial state shown in FIG. 6, is repeated by six times, and when the correspondence word list 32 is in initial state shown in FIG. 9, the loop of the step S32 to S34 is repeated by seven times, to each candidate word. The number of times of repetition properly increases depending on increase of the number of the translated expression included in the correspondence word list 32.

When presence of the co-occurrence of the whole correspondence words in relation to a certain candidate word is examined, step S34 branches to “no” side, then the co-occurrence pattern extraction section 21 extracts the co-occurrence pattern (real number vector) on the candidate word (S35). The extracted co-occurrence pattern may suitably be stored in the memory within the processing device 2.

The processing of the step S31 to S35 is repeated until the processing in relation to the whole candidate words is terminated (yes side branch of step S36), upon end of the processing in relation to the whole candidate words, the flow chart in FIG. 3 ends.

In the flow chart of FIG. 3, in the first place, one candidate word is made to select in outside loop, then in the inside loop, a correspondence word to be combined with the selected candidate word is made to change in turn, ultimately, obtained is the co-occurrence frequency about the whole combinations between the candidate word and the correspondence word; and extracted is the co-occurrence pattern. Here, substituting the inside loop for the outside loop, in the first place, one correspondence word may be made to select properly.

Next, there will be explained operation of the similarity judging section 22 using flow chart of FIG. 4. The flow chart of FIG. 4 shows the operation of the similarity judging section 22. The flow chart of FIG. 4, under the relationship with the flow chart in FIG. 2, may also indicate details of the step S23 or the like in FIG. 2.

The co-occurrence pattern extraction in relation to respective candidate words has already been completed upon having been executed the flow chart processing in FIG. 3 in relation to the first language candidate word and the second language candidate word. Consequently, in step S41 and S42 of FIG. 4, it is possible to read those co-occurrence patterns. In the first place, what is read is the first language candidate word at the step S41, next, what is read is the second language candidate word at the step S42, a candidate word combination (pair of candidate word) of two language in relation to the first language candidate word is made to change. In continuous step S43, as described above, calculated is similarity obtained in such a way as to count the number of correspondence word whose phase of the co-occurrence frequency coincides with each other in connection with pair of the respective candidate words.

In the flow chart of FIG. 4, in the first place, one candidate word of the first language is made to select in outside loop, then in the inside loop, a candidate word of the second language to be combined with the selected candidate word of the first language is made to change in turn, ultimately, calculated is the similarity about the whole combinations of the candidate words between the first language and the second language. Here, substituting the inside loop for the outside loop, one candidate word of the second language may be made to select properly in the first place.

(A-3) Effect of the First Embodiment

According to the present embodiment, it is possible to acquire the translated expression automatically upon preparing the first language corpus (31A) and the second language corpus (31B) belonging to the same field regardless of no sentence correspondence.

Moreover, in the present embodiment, it is possible to further acquire the translated expression from the same corpus (31A, 31B) while using correspondence word list (32), in which the number of the translated expression increase upon registering acquired translated expressions.

Extraction efficiency of the translated expression is improved in that the candidate word pair, which cannot be acquired because the calculated similarity is small in the state of processing with the small number of translated expression registered, may be acquired as a translated expression with high possibility in the state of processing, where the number of translated expression in the correspondence word list (32) having increased.

(B) Second Embodiment

Hereinafter, there will be explained the present embodiment in connection with its different point from the first embodiment.

In the first embodiment, since equally evaluating co-occurrence frequency pertaining to the whole words (correspondence word) included in the correspondence word list 32, appearance frequency of the word directly influences the co-occurrence frequency. For this reason, in the case that there is bias on appearance frequency of the word in the corpus (31A or 31B) and the like, it has a tendency to that degree of similarity lowers (counting result becomes not or less the threshold value TH1), the translated expression, which should be extracted properly, may not be extracted with high possibility.

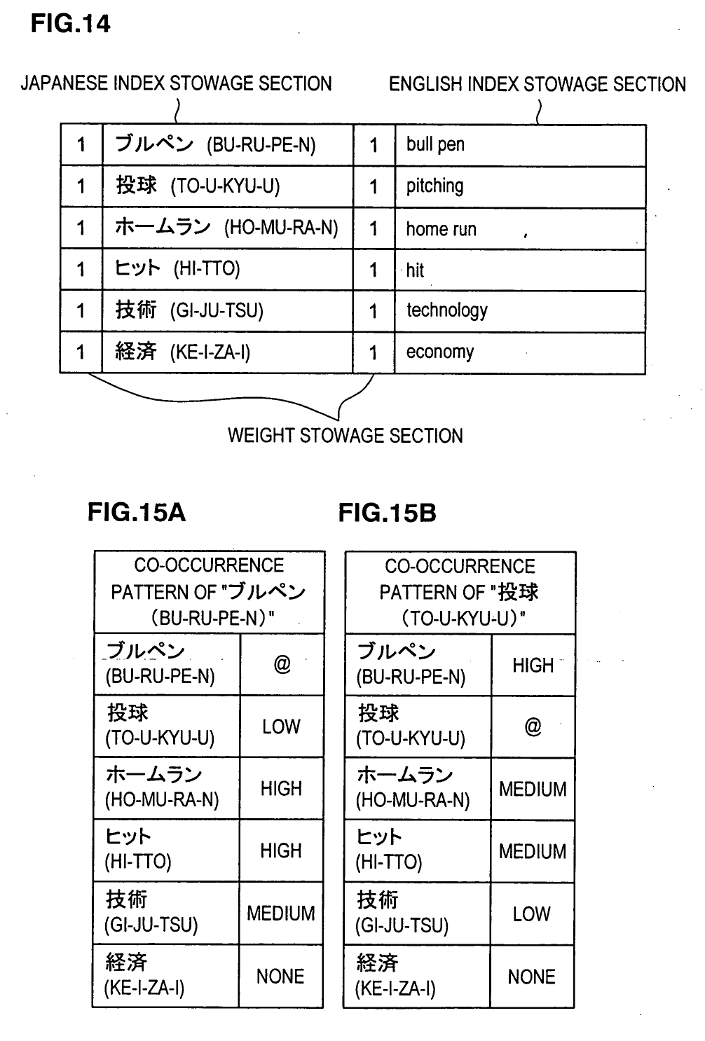

Namely, in the first embodiment, if the large number of the words (for example, “technique” in FIG. 14) of the first language, which is easy to co-occur with any word, and whose number of times of appearance is large, are included in the correspondence word list 32, the candidate word of the first language may co-occur with those words accompanied with high co-occurrence frequency. On the contrary, the word of the second language corresponding thereto in the correspondence word list has not the same character necessarily, so that, in some cases, difference in the co-occurrence pattern may be generated. A result is that degree of similarity with the second language candidate word, which should correspond to above properly lowers.

As the first embodiment, as long as the co-occurrence frequency is taken to be reference, it has tendency that the candidate word appearing frequently on its language corpus (for example, 31A) becomes high in connection with its co-occurrence frequency with the correspondence word, to the contrary, the candidate word appearing un-frequently on its language corpus (for example, 31B) becomes low in connection with its co-occurrence frequency with the correspondence word. A result is that it becomes cause of occurring error in judgment of characteristic of similarity of the co-occurrence pattern between the first language and the second language.

Thereupon, in the present embodiment, in order to solve the above-described problems, without evaluating equally the whole words included in the correspondence word list, effective word valuation for discriminating similarity characteristic of the co-occurrence pattern is made high, to the contrary, valuation of un-effective word for discrimination, which co-occurs with any word, is made low.

Specifically, as a correspondence word list (corresponding to the above-described correspondence word list 32), weight is added to respective correspondence words in a state, where weight depending on height of discrimination faculty of expression in each language (for example, the first language) is added thereto. Namely, to the co-occurrence frequency with the effective word for discriminating similarity characteristic of the co-occurrence pattern, given is weight for highly evaluating its co-occurrence frequency, to the contrary, to the co-occurrence frequency with the un-effective word for discrimination, which co-occurs with any word, given is weight, which lowers its value. By this weighting, eliminated is undesirable effect of value of the co-occurrence frequency of the correspondence word list of discrimination with large number of times of appearance, to the contrary, it is possible to properly evaluate the co-occurrence frequency of effective correspondence word list for discrimination despite of small number of times of appearance. Thus, achieved is precision improvement of the translated expression extraction.

(B-1) Constitution and Operation of the Second Embodiment

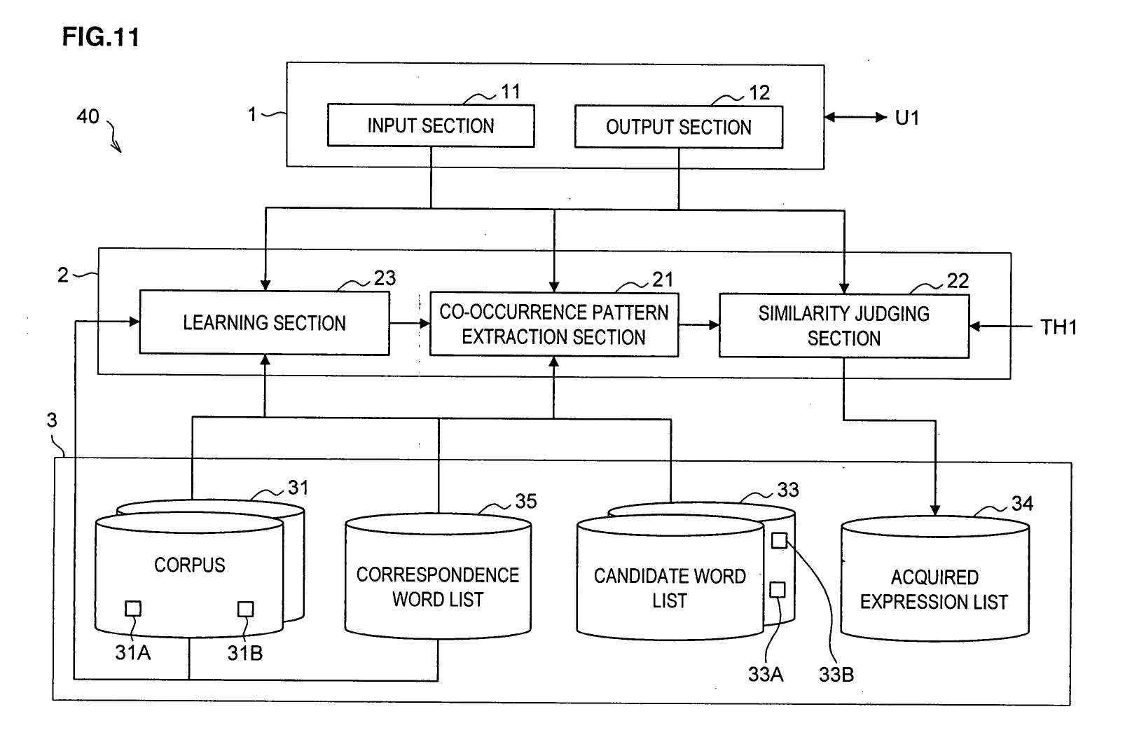

FIG. 11 shows the whole constitution example of a translated expression collection system 40 according to the present embodiment.

In FIG. 11, since function of constitution element to which the same code as FIG. 1 is added is the same as that of the first embodiment, its concrete explanation will be omitted.

The present embodiment is different from the first embodiment in that a learning section 23 is added in connection with the processing device 2, and in that internal constitution of a correspondence word list 35 is added in connection with the storage device 3.

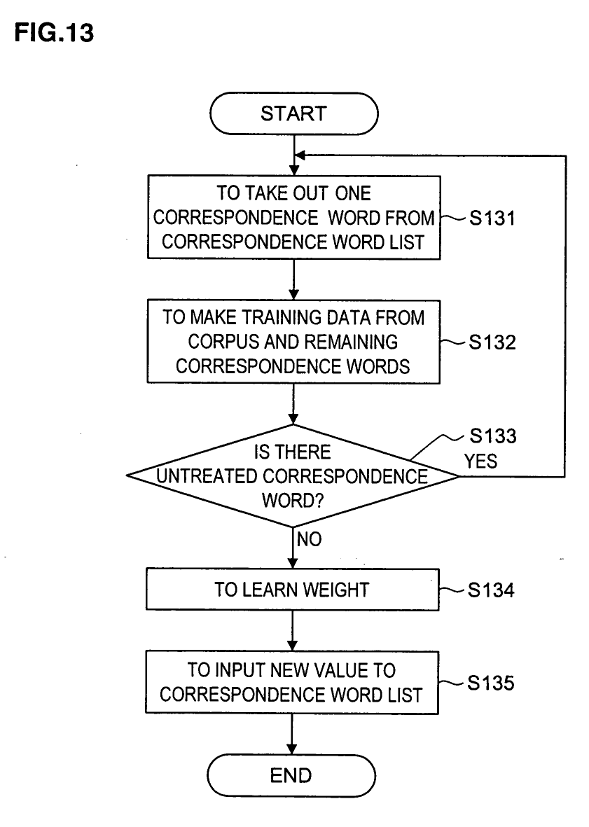

The learning section 23 is a section for performing processing of prediction of a parameter (weight) from learning data and learning algorithms. Specifically, the corpus 31 and the correspondence word list 35 are used as the learning data. Furthermore, as the learning algorithms, the decision tree, SVM (support vector machine) or the maximum entropy method can be used. As the learning algorithms, other than the above, it is possible to use all algorithms having necessary function to perform processing of later described step S134 (referring to FIG. 13).

The corpus 31 is used as the learning data in that discrimination faculty (weight) differs in every field or corpus despite of the same correspondence word. Consequently, in the present embodiment, it is necessary for the weight to learn again, when content of the corpus 31 is changed.

The discrimination faculty is faculty to significantly discriminate specified word from the other words within the concerned corpus (for example, within the first language corpus 31A). Consequently, the more the word which co-occurs with the specific word but does not co-occur with words other than the specific word, the higher it has discrimination faculty. To the contrary, the correspondence word, which does not occur with any word, or which co-occurs with every word, has low discrimination faculty. The discrimination faculty indicates relative faculty among correspondence words registered in the correspondence word list 35. Consequently, the words described here are the correspondence words (the same word as the correspondence word appearing on corpus (for example, 31A)).

Internal constitution of the correspondence word list 35 may suitably be indicated, for example, in FIG. 14. The correspondence word list 35 is different from the correspondence word list 32 of the first embodiment in that it has weight storage section.

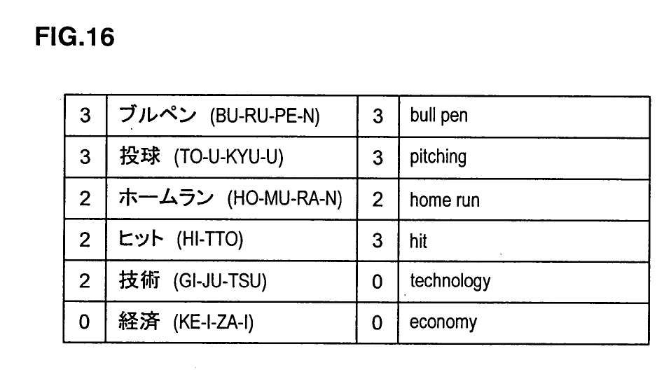

FIG. 14 shows initial state of the correspondence word list 35. At this time, all weight values stored in the weight storage section are of “1”, which indicates standard value. FIG. 16 is a diagram showing one example of the correspondence word list 35 after the learning section 23 learns weight and stores weight value depending on learning result.

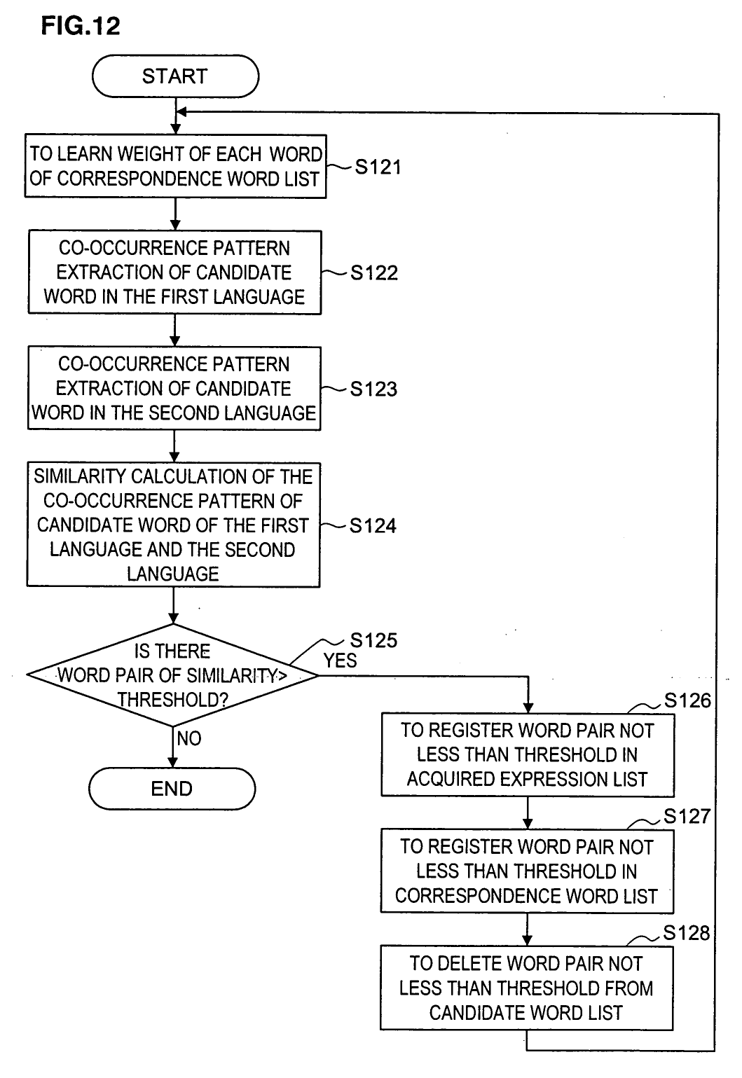

FIG. 12 and FIG. 13 are flow charts showing operation examples of the present embodiment. The flow chart of FIG. 12 is constituted by respective steps of S121 to S128; and the flow chart of FIG. 13 is constituted by respective steps of S131 to S135. The flow chart of FIG. 12 corresponds to the flow chart of FIG. 2 already explained. Difference between FIG. 12 and FIG. 2 is that only step S121 for executing learning of the weight exists therein.

Indicated in the flow chart of FIG. 13 is details of processing in connection with the weight learning.

In FIG. 13, first, one correspondence word is taken out from the correspondence word list 35 (S131); then a learning data (training data) is made to prepare on the basis of the corpus 31 and remaining correspondence words (S132). For example, as shown in FIG. 14, assuming that “ [symbol] (bu-ru-pe-n)” is taken out as the correspondence word at the step S131 from the correspondence word list 35 under the state that six correspondence words per one language is stored. At this time, remaining correspondence words which become basis of the learning data, as shown in FIG. 15(A), are five words other than the “ [symbol] (bu-ru-pe-n)” to which “@” is added. FIG. 15(B) shows a case of taking out a correspondence word “ [symbol] (to-u-kyu-u)” at step S131.

The learning data is prepared while repeating the processing of the steps S131, S132 until un-processing correspondence words are out (yes side branch of S133). As soon as the un-processing correspondence words are out, step S133 branches no side, and it executes learning of weight on the basis of the prepared learning data (S134). Then, the weight depending on the learning result is made to store in the weight storage section of the correspondence word list 35 (S135).

In this learning, examined is that how each remarked correspondence word (for example, “ [symbol] (bu-ru-pe-n)”), which is taken out at the step S131, co-occurs with another correspondence words (for example, “ [symbol] (to-u-kyu-u)” or “ [symbol] (ho-mu-ra-n)” or the like), which are registered in the correspondence word list 35, on the corpus 31 (here, the first language corpus 31A).

Weight addition depends on concrete weight deciding method. For example, in the case that weight value is decided on the basis of only the number of “high” of phase of co-occurrence frequency, since “ [symbol] (to-u-kyu-u)” shown in FIG. 15(B) is that the number of “high” is one, and “ [symbol] (bu-ru-pe-n)” shown in FIG. 15(A) is that the number of “high” is two, large value of weight is added to “ [symbol] (bu-ru-pe-n)”. However, in the example of FIG. 16, added is the same value (3) to “ [symbol] [symbol] (bu-ru-pe-n)” and “ [symbol] (to-u-kyu-u)” upon using more complicated deciding method in a state where the number of “medium” of phase of co-occurrence frequency is taken into consideration.

Upon completion of weight addition while storing weight values in the weight storage section in connection with the whole correspondence words within the correspondence word list 35, from step S122 shown in FIG. 12 on, processing starts.

(B-2) Effect of the Second Embodiment

According to the present embodiment, it is possible to obtain the same effect as that of the first embodiment.

In addition, in the present embodiment, since similarity degree judgment processing with weight added, in a state where the weight is one depending on degree of importance (discrimination faculty) of the correspondence word can be performed, even though when there is bias in co-occurrence frequency of the word in the corpus (31A or 31B), it is possible to extract translated expression more precisely and effectively than the first embodiment.

(C) The Other Embodiment

As described above, it is possible to eliminate the acquired expression list 34.

In the first embodiment and the second embodiment, explained is the case in which the candidate word or the correspondence word is a word, however, it is possible to replace this word with phrase or idiom or the like comprised of a plurality of words. The same matter is formed in connection with co-occurrence or discrimination faculty.

For example, about the co-occurrence, it is suitable that the case in which the candidate word and a plurality of correspondence words appear simultaneously within a fixed range is regarded as co-occurrence, which may be taken to as an object of counting. Further, it is possible that decision of discrimination faculty is applied to phrase or idiom.

Furthermore, in the first and the second embodiments, the utilized is the candidate word, the correspondence word or the corpus as it is basically. However, it may suitably be performed processing, after normalizing shape of the words upon previously performing the morphological analysis processing. Furthermore, about extraction of the co-occurrence, not only coincidence of the index of the candidate word and the correspondence word, but also attribute value such as part of speech, forms of words or mean information, modification information obtained from result of syntax analysis or the like are taken to be conditions, and it may suitably perform counting in the case that only the condition coincides with each other.

Moreover, in spite of the first and the second embodiment, the corpus 31 or various kinds of lists 32 to 34 are not stored in the local storage device 3, but it may suitably be a shape referring thereto via the network.

This way, in the above first and the second embodiment, the described is the case of acquiring pair of the candidate words as the translated expression, in which the similarity degree exceeds the threshold value TH1 predetermined previously, however, a case may suitably be permitted where the candidate words and the similarity degrees are output; and the user U1 can directly specify whether or not the user U1 acquires it as the translated expression.

In the above description, the present invention is realized on the hardware, however, the present invention is capable of being realized by using software.

1. A translated expression extraction apparatus comprising:
a corpus storage section for storing corpora of a first language and a second language;
a translated expression storage section in which wording of the first language and wording of the second language, whose correspondence relationship has previously been confirmed, are associated with each other to register therein as translated expression;
a degree of similarity calculation section which calculates degree of similarity indicating height of similarity of respective co-occurrence conditions while comparing co-occurrence conditions between first candidate wording to be wording extracted from the first language corpus and one kind or plural kinds of the wording of the first language registered in the translated expression storage section, with co-occurrence conditions between second candidate wording to be wording extracted from the second language corpus and one kind or plural kinds of the wording of the second language registered in the translated expression storage section; and
an additional registration section in which the first candidate wording and the second candidate wording, which have relationship that the degree of similarity obtained by the degree of similarity calculation section as calculation result is higher value than predetermined threshold value, are associated with each other, and then it is additionally registered in the translated expression storage section as a new translated expression, wherein,
performed is additional registration of the new translated expression upon operating the degree of similarity calculation section and the additional registration section on the basis of the translated expression storage section, after having performed the additional registration.

2. The translated expression extraction apparatus according to claim 1, wherein weight information according to height of discrimination faculty is added to respective wording of the first language and wording of the second language in the translated expression storage section, and performed is calculation of the degree of similarity on the basis of the weight information in the degree of similarity calculation section.

3. The translated expression extraction apparatus according to claim 2, further comprising a learning process section for leaning the weight information while executing learning processing corresponding to predetermined learning algorithms on the basis of the corpora of the first language and the second language and contents of the translated expression storage section.

4. The translated expression extraction apparatus according to claim 3, wherein when the translated expression is registered additionally in the translated expression storage section or is deleted, the learning process section learns weight information, and updates value of the weight information registered in the translated expression storage section according to learning result.

5. A translated expression extraction method comprising the steps of:
storing corpora of a first language and a second language in a corpus storage section, and associating wording of the first language with wording of the second language, whose correspondence relationship have previously been confirmed, and registering them in the translated expression storage section as the translated expression;
calculating degree of similarity indicating height of similarity of respective co-occurrence conditions upon comparing co-occurrence conditions between first candidate wording to be wording extracted from the first language corpus and one kind or plural kinds of wording of the first language registered in the translated expression storage section by the degree of similarity calculation section, with co-occurrence conditions between second candidate wording to be wording extracted from the second language corpus and one kind or plural kinds of wording of the second language registered in the translated expression storage section;
associating the first candidate wording with the second candidate wording which have relationship that the degree of similarity obtained by the degree of similarity calculation section as calculation results are higher value than predetermined threshold value, and additionally registering in the translated expression storage section as a new translated expression by the additional registration section; and
performing additional registration of the new translated expression while operating the degree of similarity calculation section and the additional registration section on the basis of the translated expression storage section, after having performed the additional registration.

6. The translated expression extraction method according to claim 5, further comprising the steps of:
associating wording of the first language with wording of the second language, and adding weight information according to height of discrimination faculty to respective wording of the first language and wording of the second language when registering them in the translated expression storage section as the translated expression, wherein,
performed is calculation of the degree of similarity on the basis of the weight information in the degree of similarity calculation section.

7. The translated expression extraction method according to claim 6, further comprising the step of:
learning the weight information while executing learning processing corresponding to predetermined learning algorithms on the basis of the corpus of the first language and the second language and contents of the translated expression storage section by the learning process section.

8. The translated expression extraction method according to claim 7, wherein when the translated expression is registered additionally in the translated expression storage section or is deleted from the same, the learning process section leans weight information, and updates value of the weight information registered in the translated expression storage section depending on learning result.

9. A translated expression extraction program, which causes a computer to realize functions, comprising;
a corpus storage function for storing corpora of a first language and a second language;
a translated expression storage function in which wording of the first language and wording of the second language, whose correspondence relationship has previously been confirmed, are associated with each other to register as translated expression;
a degree of similarity calculation function which calculates degree of similarity indicating height of similarity of respective co-occurrence conditions, upon comparing co-occurrence conditions between first candidate wording to be wording extracted from the first language corpus and one kind or plural kinds of wording of the first language registered by the translated expression storage function, with co-occurrence conditions between second candidate wording to be wording extracted from the second language corpus and one kind or plural kinds of wording of the second language registered by the translated expression storage function; and
an additional registration function for associating the first candidate wording with the second candidate wording, which have a relationship that the degree of similarity obtained by the degree of similarity calculation function as calculation result is higher value than predetermined threshold value, and then it causes the translated expression storage function to register additionally as a new translated expression, wherein,
an additional registration of the new translated expression is made to perform while operating the degree of similarity calculation function and the additional registration function on the basis of the translated expression storage function, after having performed the additional registration.

10. The translated expression extraction program according to claim 9, wherein weight information according to height of discrimination faculty is added to respective wording of the first language and wording of the second language by the translated expression storage function; and performed is calculation of the degree of similarity on the basis of the weight information by the degree of similarity calculation function.

11. The translated expression extraction program according to claim 10, further comprising a learning processing function for leaning the weight information while executing learning processing corresponding to predetermined learning algorithms on the basis of the corpora of the first language and the second language and contents of the translated expression storage section.

12. The translated expression extraction program according to claim 11, wherein when the translated expression is registered additionally or deleted by the translated expression storage function, the learning processing function leans weight information, and value of the weight information is further updated by the translated expression storage function according to learning result.
